(19) United States
(12) Patent Application Publication
(10) Pub. No.: US 2025/0382022 A1
(43) Pub. Date: Dec. 18, 2025

(54) AERODYNAMIC SYSTEM FOR A MOTOR VEHICLE

(71) Applicants: Nitesh Ambastha, Ambastha, CT (US); Trupti Heramb Awati, Riverside, CT (US)

(72) Inventor: Ishan Ambastha, Riverside, CT (US)

(21) Appl. No.: 18/747,018

(22) Filed: Jun. 18, 2024

(51) Int. Cl. B62D 35/00; B62D 37/02

(52) U.S. Cl. CPC B62D 35/008; B62D 37/02

(57) ABSTRACT

An aerodynamic system can include a first canard extending from a first surface of a body of an automobile; one or more actuators operably coupled to the first canard, the one or more actuators being configured at least to rotate the first canard about a rotational axis generally perpendicular to the first surface of the body; one or more controllers in operable communication with at least the one or more actuators, wherein the one or more controllers are configured at least to: send at least a first command signal to the one or more actuators to rotate the first canard from a first angle to a second angle; send at least a second command signal to the one or more actuators to rotate the first canard from the second angle to a third angle; wherein the third angle is different than the first angle and the second angle.

### TECHNICAL FIELD

The embodiments generally relate to the field of aerodynamic systems for motor vehicles.

### BACKGROUND

A typical aerodynamic system for a motor vehicle may include a canard whose position and orientation is fixed relative to the motor vehicle. Such an aerodynamic system cannot dynamically control the air resistance and stability of the motor vehicle while the motor vehicle is driven.

There is a need for an aerodynamic system for a motor vehicle that dynamically controls the air resistance and stability of the motor vehicle while the motor vehicle is driven.

### SUMMARY

This summary is provided to introduce a variety of concepts in a simplified form that is further disclosed in the detailed description of the embodiments. This summary is not intended to identify key or essential inventive concepts of the claimed subject matter, nor is it intended for determining the scope of the claimed subject matter.

In general, the disclosed aerodynamic system can include a first canard extending from a first surface of a body of an automobile; one or more actuators operably coupled to the first canard, the one or more actuators being configured at least to rotate the first canard about a rotational axis generally perpendicular to the first surface of the body; one or more controllers in operable communication with at least the one or more actuators, wherein the one or more controllers are configured at least to: send at least a first command signal to the one or more actuators to rotate the first canard from a first angle to a second angle; send at least a second command signal to the one or more actuators to rotate the first canard from the second angle to a third angle; wherein the third angle is different than the first angle and the second angle.

Other illustrative variations within the scope of the invention will become apparent from the detailed description provided hereinafter. The detailed description and enumerated variations, while disclosing optional variations, are intended for purposes of illustration only and are not intended to limit the scope of the invention.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1 illustrates an aerodynamic system mounted on a motor vehicle, according to some embodiments disclosed herein;

FIG. 2 illustrates a diagram of an aerodynamic system mounted on a motor vehicle, according to some embodiments disclosed herein;

FIGS. 3A-3C illustrate an aerodynamic system mounted on a motor vehicle with canards rotated at different angles, according to some embodiments disclosed herein;

FIG. 4 illustrates a diagram of an aerodynamic system mounted on a motor vehicle, including an electric motor, according to some embodiments disclosed herein;

FIGS. 5A and 5B illustrate a diagram of an aerodynamic system mounted on a motor vehicle, including a hydraulic cylinder, according to some embodiments disclosed herein; and

FIG. 6 illustrates a block diagram of example hardware of a controller, according to some embodiments disclosed herein.

The drawings are not necessarily to scale, and certain features and certain views of the drawings may be shown exaggerated in scale or in schematic in the interest of clarity and conciseness.

### DETAILED DESCRIPTION

The specific details of the single embodiment or variety of embodiments described herein are to the described product or methods of use. Any specific details of the embodiments are used for demonstration purposes only and no unnecessary limitations or inferences are to be understood from there.

It is noted that the embodiments reside primarily in combinations of components and procedures related to the products. Accordingly, the product and components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments described herein relate to an aerodynamic system for a motor vehicle. In some embodiments, the aerodynamic system can be mounted on the motor vehicle. In some embodiments, the motor vehicle can be any automobile such as, for example, a car, a truck, a sports utility vehicle, a crossover, etc.

In some embodiments, the aerodynamic system can include at least one canard extending from one or more surfaces of a body of an automobile and one or more actuators operably coupled to the at least one canard. The one or more actuators can be configured at least to rotate the at least one canard to increase stability of the motor vehicle while the motor vehicle is driven.

In some embodiments, the at least one canard can be made primarily of any suitable durable material such as, metal, plastic, wood, any other suitable durable material(s), or any combination thereof.

In some embodiments, a canard can include any suitable wing that is constructed and arranged to be mounted to a body of a motor vehicle. In some embodiments, the canard can include a wing and any suitable number of winglets attached to the wing.

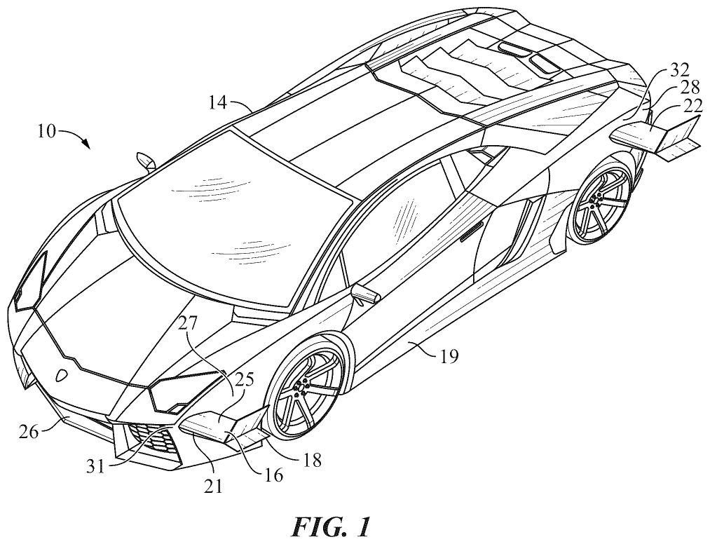

Referring to FIG. 1, an aerodynamic system 10 can include at least a first canard 21 extending from a first surface 31 of a body 19 of a motor vehicle such as an automobile 14. In some embodiments, the aerodynamic system 10 can include at least a second canard 22 extending from a second surface 32 of the body 19. In some embodiments, the aerodynamic system 10 can include any suitable number of canards such as one canard, two canards, three canards, etc. In some embodiments, each canard 21, 22 can include a wing 16. In some embodiments, at least one winglet 18 can be attached to the wing 16. In some embodiments, the wing 16 can include a plate 25 that extends from the first surface 31 of the body 19.

In some embodiments, the first surface 31 can be a surface of a front fender 27 of the automobile 14. In some embodiments, the first surface 31 can be a surface of a front bumper 26 of the automobile 14. In some embodiments, the second surface 32 can be a surface of a back fender 28 of the automobile 14.

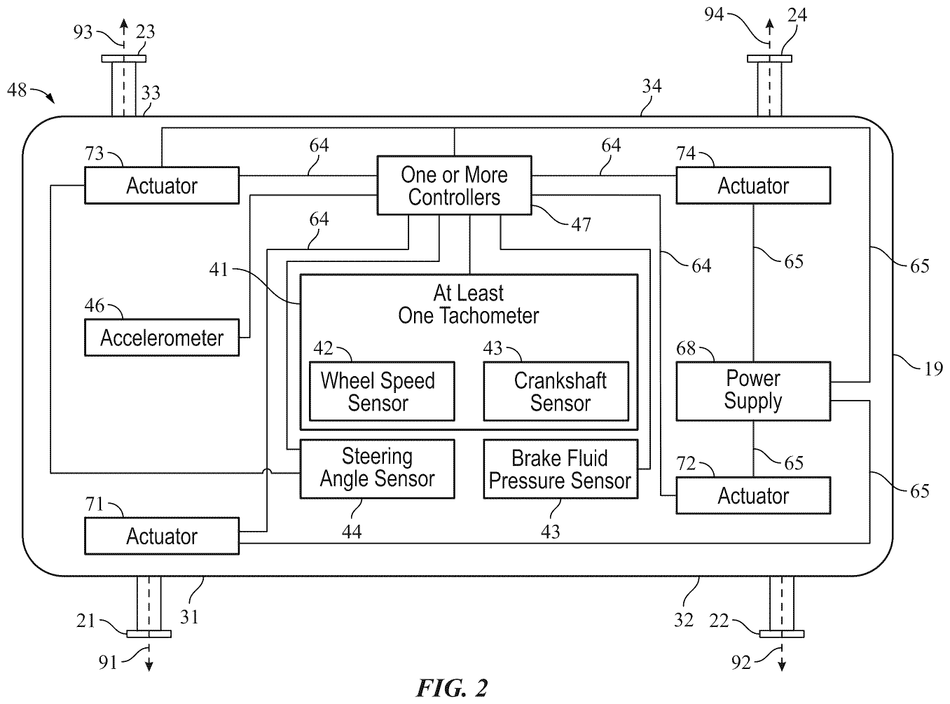

Referring to FIG. 2, the aerodynamic system 10 can include a third canard 23 extending from a third surface 33 of the body 19. In some embodiments, the aerodynamic system 10 can include a fourth canard 24 extending from a fourth surface 34 of the body 19.

In some embodiments, the aerodynamic system 10 can include one or more actuators 48 operably coupled to any of the canards 21, 22, 23, 24. In some embodiments, the one or more actuators 48 can include a first actuator 71 that is configured at least to rotate the first canard 21 about a first rotational axis 91. In some embodiments, the rotational axis 91 can be generally perpendicular to the first surface 31 of the body 19. In some embodiments, the one or more actuators 48 can include a second actuator 72 that is configured at least to rotate the second canard 22 about a second rotational axis 92. In some embodiments, the second rotational axis 92 can be generally perpendicular to the second surface 32 of the body 19. In some embodiments, the one or more actuators 48 can include a third actuator 73 that is configured at least to rotate the third canard 23 about a third rotational axis 93 generally perpendicular to the third surface 33 of the body 19. In some embodiments, the one or more actuators 48 can include a fourth actuator 74 that is configured at least to rotate the fourth canard 24 about a fourth rotational axis 94 generally perpendicular to the fourth surface 34 of the body 19.

In some embodiments, one or more controllers 47 can be in operable communication with at least the one or more actuators 48. For example, the one or more controllers 47 can be connected to the one or more actuators 48 via communication connections 64. In some embodiments communication connections 64 can include any suitable connections that are suitable for communicating command signals to the one or more actuators 48. For example, the communication connections 64 can include electrical connections, optical connections, or a combination thereof. In some embodiments, communication connections 64 can include wireless connections.

In some embodiments, the one or more controllers 47 can be configured at least to send command signals to any of the one or more actuators 48 so that any of the one or more actuators 48 rotate any canard 21, 22, 23, 24 from any angle to any other angle.

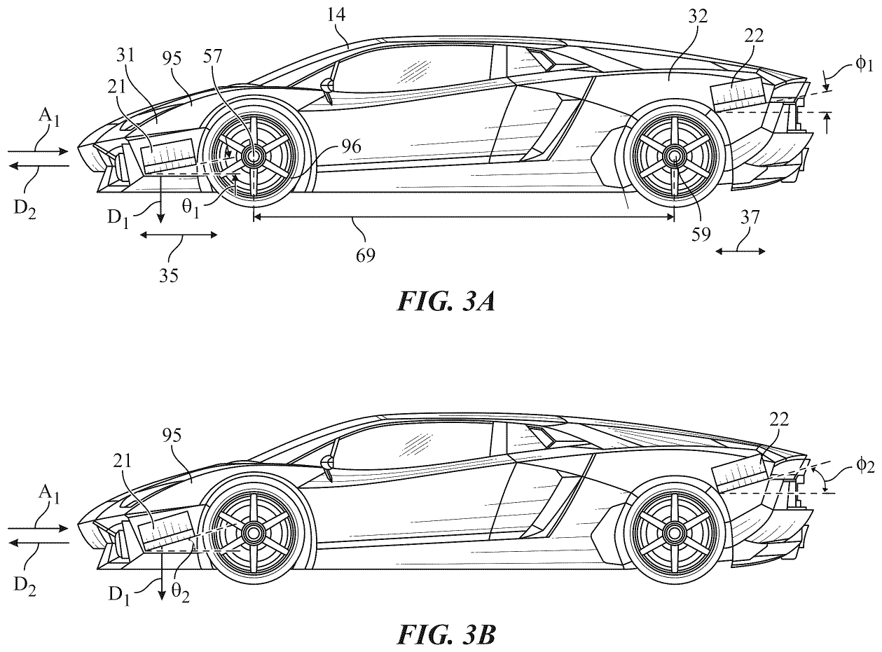

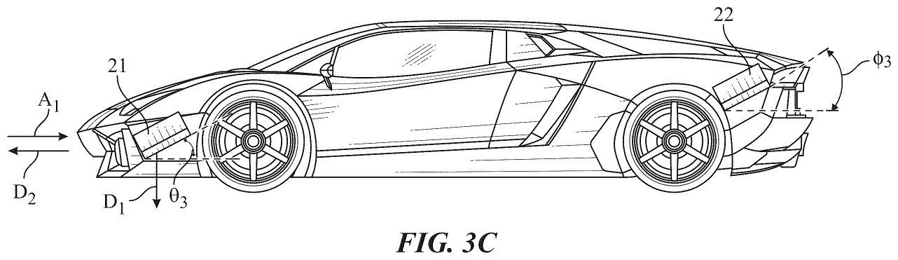

For example, referring to FIGS. 3A and 3B, the one or more controllers (e.g., 47 in FIG. 2) can be configured to send at least a first command signal to any actuator such as the first actuator (e.g., 71 in FIG. 2) to rotate any canard such as the first canard 21 from a first angle θ₁ to a second angle θ₂ that is different from the first angle θ₁. In some embodiments, the second angle θ₂ can be larger than the first angle θ₁. In some embodiments, rotating the first canard 21 from the first angle θ₁ to the second angle θ₂ can increase air resistance so that an air flow A₁ pushes at least partially downward D₁ on the canard 21 while the automobile is driven in a direction D₂, which pushes at least partially downward D₁ on the front portion 95 of the automobile 14, thereby increasing stability of the automobile 14.

As another example, referring to FIGS. 3B and 3C, the one or more controllers (e.g., 47 in FIG. 2) can be configured to send at least a second command signal to any actuator such as the first actuator (e.g., 71 in FIG. 2) to rotate any canard such as the first canard 21 from the second angle θ₂ to a third angle θ₃, wherein the third angle θ₃ is different from the first angle θ₁ and the second angle θ₂. In some embodiments, the third angle θ₃ is larger than the first angle θ₁ and the second angle θ₂. In some embodiments, rotating the first canard 21 from the second angle θ₂ to the third angle θ₃ can further increase air resistance so that an air flow A₁ pushes on the canard 21 with an increased force downward D₁ while the automobile is driven in a direction D₂, which pushes on the front portion 95 with an increased force downward D₁, thereby further increasing stability of the automobile 14.

In some embodiments, the first angle θ₁, the second angle θ₂, and the third angle θ₃ can be measured relative to any suitable direction. For example, referring to FIG. 3A, the first angle θ₁, the second angle θ₂, and the third angle θ₃ can be measured relative to a horizontal direction 35 or a horizontal direction 37. In some embodiments, the first angle θ₁, the second angle θ₂, and the third angle θ₃ can be within any suitable range. For example, the first angle θ₁, the second angle θ₂, and the third angle θ₃ can be within the range from 0° to 360°. In some embodiments, the horizontal direction 35 or the horizontal direction 37 can be generally parallel to a horizontal direction 69 extending from a first wheel hub 57 to a second wheel hub 59. In some embodiments, the canards 21, 22, 23, 24 can be rotated independently of one another. In some embodiments, the canards 21, 22, 23, 24 can be rotationally fixed to each other. In some embodiments, the canards 21, 22, 23, 24 can be rotated to any other suitable angle(s) in the range from 0° to 360°.

Referring back to FIG. 2, in some embodiments, the aerodynamic system 10 can include at least one tachometer 41 in operable communication with the one or more controllers 47. In some embodiments, the one or more controllers 47 can be configured to receive first tachometer data and second tachometer data from the at least one tachometer 41. In some embodiments the first tachometer data can indicate a first speed of the automobile 14. In some embodiments, the one or more controllers 47 can be configured to send, in response to at least receiving the first tachometer data from the at least one tachometer 41, at least the first command signal to at least the first actuator 71 to rotate the first canard 21 from the first angle θ₁ to the second angle θ₂.

In some embodiments the second tachometer data can indicate a second speed of the automobile 14 that is larger than the first speed. In some embodiments, the one or more controllers 47 can be configured to send, in response to at least receiving the second tachometer data from the at least one tachometer 41, at least the second command signal to at least the first actuator 71 to rotate the first canard 21 from the second angle θ₂ to the third angle θ₃.

In some embodiments, the at least one tachometer 41 can include at least one wheel speed sensor 42. In some embodiments, the first tachometer data and the second tachometer data can include first wheel speed sensor data and second wheel speed sensor data from the at least one wheel speed sensor 42. In some embodiments, the first wheel speed sensor data and the second wheel speed sensor data can respectively indicate at least a first rotational speed and a second rotational speed of any wheel 96 of the automobile 14.

In some embodiments, the at least one tachometer 41 can include at least one crankshaft sensor 43. In some embodiments, the first tachometer data and the second tachometer data can include first crankshaft sensor data and second crankshaft sensor data from the at least one crankshaft sensor 43. In some embodiments, the first crankshaft sensor data and the second crankshaft sensor data can respectively indicate at least a first rotational speed and a second rotational speed of a crankshaft of an engine of the automobile 14.

In some embodiments, the aerodynamic system 10 can include at least one steering angle sensor 44 in operable communication with the one or more controllers 47. In some embodiments, the one or more controllers 47 can be configured to receive first steering angle sensor data and second steering angle sensor data from the at least one steering angle sensor 44. In some embodiments, the first steering angle sensor data can indicate a first angle by which a steering wheel of the automobile 14 is rotated. In some embodiments, the second steering angle sensor data can indicate a second angle by which the steering wheel of the automobile 14 is rotated. A larger angle by which the steering wheel of the automobile 14 is rotated can indicate that the automobile 14 is making a sharper turn (e.g., left turn or right turn).

In some embodiments, the one or more controllers 47 can be configured to send, in response to at least receiving the first steering angle sensor data from the at least one steering angle sensor 44, at least the first command signal to the first actuator 71 to rotate the first canard 21 from the first angle θ₁ to the second angle θ₂. In some embodiments, the one or more controllers 47 can be configured to send, in response to at least receiving the second steering angle sensor data from the at least one steering angle sensor 44, at least the second command signal to the first actuator 71 to rotate the first canard 21 from the second angle θ₂ to the third angle θ₃.

In some embodiments, the aerodynamic system 10 can include at least one brake fluid pressure sensor 45 in operable communication with the one or more controllers 47. In some embodiments, the one or more controllers 47 can be configured to receive first brake fluid pressure sensor data and second brake fluid pressure sensor data from the at least one brake fluid pressure sensor 45. In some embodiments, the first brake fluid pressure sensor data and the second brake fluid pressure sensor data can indicate brake fluid pressures of the automobile 14. A higher brake fluid pressure can indicate that the automobile is decelerating at a faster rate.

In some embodiments, the one or more controllers 47 can be configured to send, in response to at least receiving the first brake fluid pressure sensor data from the at least one brake fluid pressure sensor 45, at least the first command signal to the first actuator 71 to rotate the first canard 21 from the first angle θ₁ to the second angle θ₂. In some embodiments, the one or more controllers 47 can be configured to send, in response to at least receiving the second brake fluid pressure sensor data from the at least one brake fluid pressure sensor 45, at least the second command signal to the first actuator 71 to rotate the first canard 21 from the second angle θ₂ to the third angle θ₃.

In some embodiments, the aerodynamic system 10 can include at least one accelerometer 46 in operable communication with the one or more controllers 47. In some embodiments, the one or more controllers 47 can be configured to receive first accelerometer data and second accelerometer data from the at least one accelerometer 46. In some embodiments, the first accelerometer data and the second accelerometer data can respectively indicate first and second accelerations of the automobile 14.

In some embodiments, the one or more controllers 47 can be configured to send, in response to at least receiving the first accelerometer data from the at least one accelerometer 46, at least the first command signal to the first actuator 71 to rotate the first canard 21 from the first angle θ₁ to the second angle θ₂. In some embodiments, the one or more controllers 47 can be configured to send, in response to at least receiving the second accelerometer data from the at least one accelerometer 46, at least the second command signal to the first actuator 71 to rotate the first canard 21 from the second angle θ₂ to the third angle θ₃.

Referring back to FIG. 2, at least one power supply 68 can be constructed and arranged to provide any necessary power to any of the one or more actuators 48. In some embodiments, the at least one power supply 68 can be electrically connected to any of the one or more actuators 48 and/or the one or more controllers 47 via electrical connections 65.

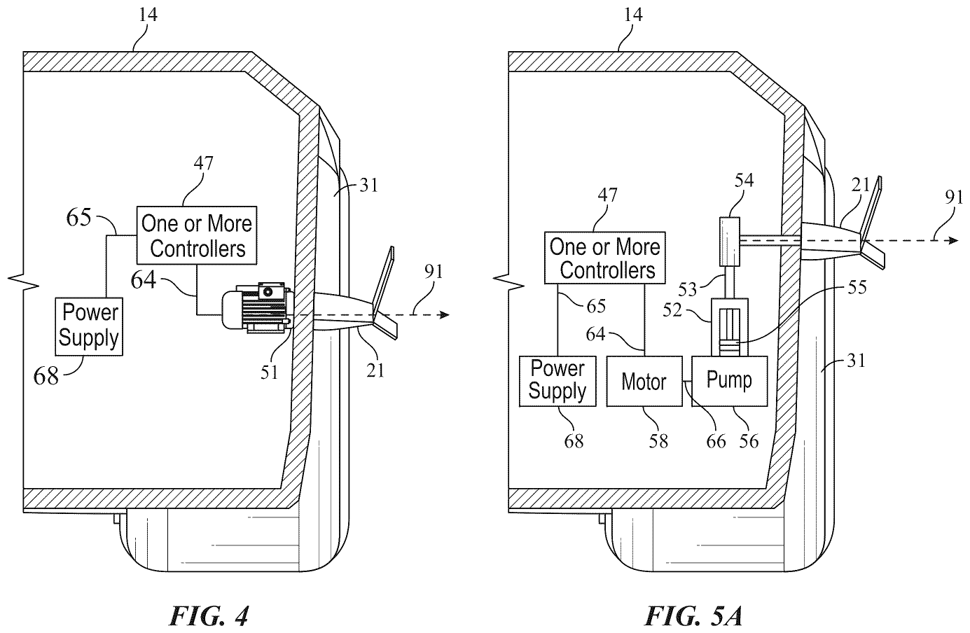

Referring to FIG. 4, in some embodiments, the one or more actuators 48 in FIG. 2 can include at least one electric motor 51 in rotational communication with the first canard 21. In some embodiments, the electric motor 51 can be constructed and arranged to rotate the first canard 21 about the rotational axis 91.

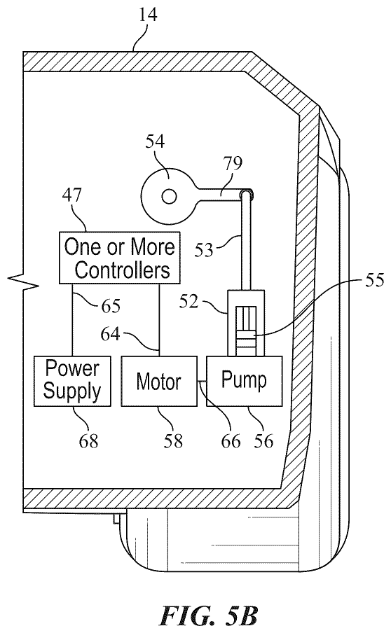

Referring to FIGS. 5A and 5B, in some embodiments, the one or more actuators 48 in FIG. 2 can include at least one hydraulic cylinder 52 having a piston 55 and piston rod 53. In some embodiments, the piston rod 53 can be in mechanical communication with the first canard 21. For example, the piston rod 53 can be attached to a crank 54, and the crank 54 can be in rotational communication with the first canard 21. In some embodiments, the piston rod 53 can be attached to an arm 79 of the crank 54. A hydraulic pump 56 can be operably coupled to the hydraulic cylinder 52. A hydraulic pump actuator such as an electric motor 58 can be constructed and arranged to actuate the hydraulic pump 56 so that the hydraulic cylinder 52 rotates the first canard 21 about the rotational axis 91. The hydraulic pump actuator can be any actuator that is constructed and arranged to actuate the hydraulic pump 56. The electric motor 58 can be connected to the pump 56 via a mechanical connection 66. In some embodiments, the at least one power supply 68 can be electrically connected to the electric motor 58 via an electrical connection 65.

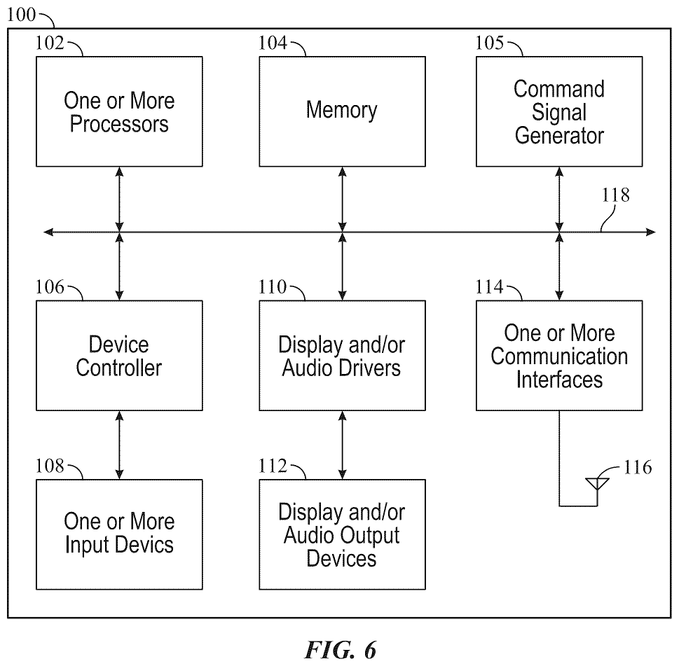

Referring to FIG. 6, an example hardware of a controller 100 is illustrated. In some embodiments, the controller 100 can include one or more processors 102, memory 104, a command signal generator 105, a device controller 106, one or more input devices 108, display and/or audio drivers 110, display and/or audio output devices 112, one or more communication interfaces 114, one or more antennas 116, a bus 118, or any combination thereof.

In some embodiments, the one or more processors 102 can include any suitable hardware processor, such as a central processing unit (CPU), a graphics processing unit (GPU), a tensor processing unit (TPU), an accelerated processing unit (APU), any other type of processing unit, or any combination thereof. In some embodiments, the one or more processors 102 can include a microprocessor, a micro-controller, a digital signal processor, dedicated logic, an application-specific integrated circuit (ASIC), a field programmable gate array (FPGA), an accelerator (e.g., an artificial intelligence (AI) accelerator or a cryptographic accelerator), any other suitable circuitry for controlling the functioning of a general purpose computer or a special purpose computer, or any combination thereof.

In some embodiments, the one or more processors 102 can be controlled by a program stored in memory 104. For example, the program can cause the one or more processors 102 to determine a speed of the automobile based at least on any received data disclosed herein. In response to determining the speed of the automobile, the one or more processors 102 can determine if the speed of the automobile meets (e.g., is equal to or greater than) one or more predetermined speed thresholds. In response to determining that the speed of the automobile meets one or more predetermined speed thresholds, the processor 102 can send a command signal or instruction data to the command signal generator 105 so that the command signal generator 105 sends any command signal to any actuator (e.g., 71, 72, 73, 74 in FIG. 2) to rotate any canard (e.g., 21, 22, 23, 24 in FIG. 2) from any angle to any other angle. In some embodiments, the command signal generator 105 can send another command signal to any other actuator (e.g., 71, 72, 73, 74 in FIG. 2) to rotate any other canard (e.g., 21, 22, 23, 24 in FIG. 2) from any angle to any other angle. In some embodiments, any canard can be rotated to any angle while another canard (e.g., 22 in FIGS. 3A-3C) is rotated to any other angle (e.g., φ₁ in FIG. 3A, φ₂ in FIG. 3B, φ₃ in FIG. 3C).

As another example, the one or more processors 102 can be configured to generate a feature vector based on any data, or any combination of data disclosed herein. In some embodiments, the one or more processors 102 can be configured to provide the feature vector to a machine learning model that is configured to generate a recommended angle to which any canard is to be rotated. In response, any canard disclosed herein can be rotated to the recommended angle. In some embodiments, the machine learning model can be trained using any suitable historical data stored in memory 104. Historical data can include any data disclosed herein, including any historical sensor data.

In some embodiments, the memory 104 can include any suitable memory, storage, or a combination thereof for storing programs, data, and/or any other suitable information. For example, memory 104 can include volatile memory, non-volatile memory, or any combination thereof. In some embodiments, memory 104 can include random access memory, read-only memory, flash memory, a hard disk drive, a solid state drive, optical media, any other suitable memory, or any combination thereof.

In some embodiments, a command signal generator 105 can be configured to generate any command signals suitable for controlling any actuators disclosed herein. The one or more processors 102 can be configured to send instruction data or command signals to the command signal generator 105 to generate any command signals suitable for controlling any actuators disclosed herein.

In some embodiments, computer-readable media can be included in the memory 104. In some embodiments, the computer-readable media can store instructions that, when executed by the one or more processors 102, cause the one or more processors 102 to perform any process or subprocess disclosed herein. For example, in some embodiments, computer readable media can be transitory or non-transitory. For example, non-transitory computer readable media can include media such as magnetic media (such as hard disks, floppy disks, and/or any other suitable magnetic media), optical media (such as compact discs, digital video discs, Blu-ray discs, and/or any other suitable optical media), semiconductor media (such as flash memory, electrically programmable read-only memory (EPROM), electrically erasable programmable read-only memory (EEPROM), and/or any other suitable semiconductor media), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

In some embodiments, the device controller 106 can include any suitable processor or circuitry for controlling and receiving any input from the one or more input devices 108. In some embodiments, the one or more input devices 108 can include a touchscreen, a keyboard, a mouse, one or more buttons, a voice recognition circuit, a camera, one or more sensors, any other suitable input device, or any combination thereof. In some embodiments, the one or more sensors can include one or more accelerometers, one or more gyroscope sensors, one or more microphones, any other suitable sensors (e.g., an optical sensor, a temperature sensor, a near field sensor), or any combination thereof.

In some embodiments, the display and/or audio drivers 110 can include any suitable circuitry for controlling and driving output to one or more display and/or audio output devices 112. For example, the output devices can include a display (e.g., including a touchscreen, a flat-panel display, a cathode ray tube display, a projector, any other suitable display or presentation device, or any combination thereof), one or more speakers, or a combination thereof.

In some embodiments, the one or more communication interfaces 114 can include any suitable circuitry for interfacing with one or more communication networks. For example, the one or more communication interfaces 114 can include network interface card circuitry, wired communication circuitry, wireless communication circuitry, any other suitable communication network circuitry, or any combination thereof.

In some embodiments, the one or more antennas 116 can wirelessly communicate with a communication network. In some embodiments, the one or more antennas 116 can be omitted.

In some embodiments, the bus 118 can include any suitable communication system for communicating data, addresses, control signals, power, or any combination thereof, between two or more components 102, 104, 105, 106, 110, and 114. In some embodiments, the bus 118 can include any suitable conductors that are constructed and arranged to communicate data, addresses, control signals, power, or any combination thereof, between two or more components 102, 104, 105, 106, 110, and 114.

In some embodiments, any other suitable component(s) can be included in the controller 100. In some embodiments, the controller 100 can be embodied as, or otherwise included in, an electronic control unit (ECU) of the automobile 14.

According to variation 1, an aerodynamic system can include a first canard extending from a first surface of a body of an automobile; one or more actuators operably coupled to the first canard, the one or more actuators being configured at least to rotate the first canard about a rotational axis generally perpendicular to the first surface of the body; one or more controllers in operable communication with at least the one or more actuators, wherein the one or more controllers are configured at least to: send at least a first command signal to the one or more actuators to rotate the first canard from a first angle to a second angle; send at least a second command signal to the one or more actuators to rotate the first canard from the second angle to a third angle; wherein the third angle is different than the first angle and the second angle.

According to variation 2, an aerodynamic system can include a first canard extending from a first surface of a body of an automobile; one or more actuators operably coupled to the first canard, the one or more actuators being configured at least to rotate the first canard about a rotational axis extending through the first surface of the body; one or more controllers in operable communication with at least the one or more actuators, wherein the one or more controllers are configured at least to: send at least a first command signal to the one or more actuators to rotate the first canard from a first angle to a second angle; send at least a second command signal to the one or more actuators to rotate the first canard from the second angle to a third angle; wherein the third angle is different than the first angle and the second angle.

According to variation 3, an aerodynamic system can include a first canard extending from a first surface of a body of an automobile; one or more actuators operably coupled to the first canard, the one or more actuators being configured at least to rotate the first canard; one or more controllers in operable communication with at least the one or more actuators, wherein the one or more controllers are configured at least to: send at least a first command signal to the one or more actuators to rotate the first canard from a first angle to a second angle; send at least a second command signal to the one or more actuators to rotate the first canard from the second angle to a third angle; wherein the third angle is different than the first angle and the second angle.

Variation 4 can include the aerodynamic system of variation 1, variation 2, or variation 3, further comprising: at least one tachometer in operable communication with the one or more controllers, wherein the one or more controllers are further configured to: receive first tachometer data from the at least one tachometer; and receive second tachometer data from the at least one tachometer; wherein sending at least the first command signal to the one or more actuators to rotate the first canard from the first angle to the second angle includes sending, in response to at least receiving the first tachometer data from the at least one tachometer, at least the first command signal to the one or more actuators to rotate the first canard from the first angle to the second angle; wherein sending at least the second command signal to the one or more actuators to rotate the first canard from the second angle to the third angle includes sending, in response to at least receiving the second tachometer data from the at least one tachometer, at least the second command signal to the one or more actuators to rotate the first canard from the second angle to the third angle.

Variation 5 can include the aerodynamic system of variation 4, wherein the at least one tachometer includes at least one crankshaft sensor.

Variation 6 can include the aerodynamic system of variation 4, wherein the at least one tachometer includes at least one wheel speed sensor.

Variation 7 can include the aerodynamic system of variation 1, variation 2, or variation 3, further comprising: at least one steering angle sensor in operable communication with the one or more controllers, wherein the one or more controllers are further configured to: receive first steering angle sensor data from the at least one steering angle sensor; and receive second steering angle sensor data from the at least one steering angle sensor; wherein sending at least the first command signal to the one or more actuators to rotate the first canard from the first angle to the second angle includes sending, in response to at least receiving the first steering angle sensor data from the at least one steering angle sensor, at least the first command signal to the one or more actuators to rotate the first canard from the first angle to the second angle; wherein sending at least the second command signal to the one or more actuators to rotate the first canard from the second angle to the third angle includes sending, in response to at least receiving the second steering angle sensor data from the at least one steering angle sensor, at least the second command signal to the one or more actuators to rotate the first canard from the second angle to the third angle.

Variation 8 can include the aerodynamic system of variation 1, variation 2, or variation 3, further comprising: at least one brake fluid pressure sensor in operable communication with the one or more controllers, wherein the one or more controllers are further configured to: receive first brake fluid pressure sensor data from the at least one brake fluid pressure sensor; and receive second brake fluid pressure sensor data from the at least one brake fluid pressure sensor; wherein sending at least the first command signal to the one or more actuators to rotate the first canard from the first angle to the second angle includes sending, in response to at least receiving the first brake fluid pressure sensor data from the at least one brake fluid pressure sensor, at least the first command signal to the one or more actuators to rotate the first canard from the first angle to the second angle; wherein sending at least the second command signal to the one or more actuators to rotate the first canard from the second angle to the third angle includes sending, in response to at least receiving the second brake fluid pressure sensor data from the at least one brake fluid pressure sensor, at least the second command signal to the one or more actuators to rotate the first canard from the second angle to the third angle.

Variation 9 can include the aerodynamic system of variation 1, variation 2, or variation 3, further comprising: at least one accelerometer in operable communication with the one or more controllers, wherein the one or more controllers are further configured to: receive first accelerometer data from the at least one accelerometer; and receive second accelerometer data from the at least one accelerometer; wherein sending at least the first command signal to the one or more actuators to rotate the first canard from the first angle to the second angle includes sending, in response to at least receiving the first accelerometer data from the at least one accelerometer, at least the first command signal to the one or more actuators to rotate the first canard from the first angle to the second angle; wherein sending at least the second command signal to the one or more actuators to rotate the first canard from the second angle to the third angle includes sending, in response to at least receiving the second accelerometer data from the at least one accelerometer, at least the second command signal to the one or more actuators to rotate the first canard from the second angle to the third angle.

Variation 10 can include the aerodynamic system of variation 1, variation 2, or variation 3, wherein the one or more actuators include: a hydraulic cylinder having a piston and piston rod, the piston rod being in mechanical communication with the first canard; a hydraulic pump operably coupled to the hydraulic cylinder; a hydraulic pump actuator constructed and arranged to actuate the hydraulic pump so that the hydraulic cylinder rotates the first canard about the rotational axis generally perpendicular to the first surface of the body.

Variation 11 can include the aerodynamic system of variation 1, variation 2, or variation 3, wherein the one or more actuators include: an electric motor in rotational communication with the first canard, the electric motor being constructed and arranged to rotate the first canard about the rotational axis generally perpendicular to the first surface of the body.

Many different embodiments have been disclosed herein, in connection with the above description and the drawings. It will be understood that it would be unduly repetitious and obfuscating to describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for anyone of the elements in the claims below or that a single element can be substituted for two or more elements in a claim. Although elements can be described above as acting in certain combinations, and even initially claimed as such, it is to be expressly understood that one or more elements from a claimed combination can, in some cases, be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible considering the above teachings without departing from the following claims.

What is claimed is:

1. An aerodynamic system, comprising:
a first canard extending from a first surface of a body of an automobile;
one or more actuators operably coupled to the first canard, the one or more actuators being configured at least to rotate the first canard about a rotational axis generally perpendicular to the first surface of the body;
one or more controllers in operable communication with at least the one or more actuators, wherein the one or more controllers are configured at least to:
send at least a first command signal to the one or more actuators to rotate the first canard from a first angle to a second angle;
send at least a second command signal to the one or more actuators to rotate the first canard from the second angle to a third angle;
wherein the third angle is different than the first angle and the second angle.

2. The aerodynamic system of claim 1, further comprising:
at least one tachometer in operable communication with the one or more controllers, wherein the one or more controllers are further configured to:
receive first tachometer data from the at least one tachometer; and
receive second tachometer data from the at least one tachometer;
wherein sending at least the first command signal to the one or more actuators to rotate the first canard from the first angle to the second angle includes sending, in response to at least receiving the first tachometer data from the at least one tachometer, at least the first command signal to the one or more actuators to rotate the first canard from the first angle to the second angle;
wherein sending at least the second command signal to the one or more actuators to rotate the first canard from the second angle to the third angle includes sending, in response to at least receiving the second tachometer data from the at least one tachometer, at least the second command signal to the one or more actuators to rotate the first canard from the second angle to the third angle.

3. The aerodynamic system of claim 2, wherein the at least one tachometer includes at least one crankshaft sensor.

4. The aerodynamic system of claim 2, wherein the at least one tachometer includes at least one wheel speed sensor.

5. The aerodynamic system of claim 1, further comprising:
at least one steering angle sensor in operable communication with the one or more controllers, wherein the one or more controllers are further configured to:
receive first steering angle sensor data from the at least one steering angle sensor; and
receive second steering angle sensor data from the at least one steering angle sensor;
wherein sending at least the first command signal to the one or more actuators to rotate the first canard from the first angle to the second angle includes sending, in response to at least receiving the first steering angle sensor data from the at least one steering angle sensor, at least the first command signal to the one or more actuators to rotate the first canard from the first angle to the second angle;
wherein sending at least the second command signal to the one or more actuators to rotate the first canard from the second angle to the third angle includes sending, in response to at least receiving the second steering angle sensor data from the at least one steering angle sensor, at least the second command signal to the one or more actuators to rotate the first canard from the second angle to the third angle.

6. The aerodynamic system of claim 1, further comprising:
at least one brake fluid pressure sensor in operable communication with the one or more controllers, wherein the one or more controllers are further configured to:
receive first brake fluid pressure sensor data from the at least one brake fluid pressure sensor; and
receive second brake fluid pressure sensor data from the at least one brake fluid pressure sensor;
wherein sending at least the first command signal to the one or more actuators to rotate the first canard from the first angle to the second angle includes sending, in response to at least receiving the first brake fluid pressure sensor data from the at least one brake fluid pressure sensor, at least the first command signal to the one or more actuators to rotate the first canard from the first angle to the second angle;
wherein sending at least the second command signal to the one or more actuators to rotate the first canard from the second angle to the third angle includes sending, in response to at least receiving the second brake fluid pressure sensor data from the at least one brake fluid pressure sensor, at least the second command signal to the one or more actuators to rotate the first canard from the second angle to the third angle.

7. The aerodynamic system of claim 1, further comprising:
at least one accelerometer in operable communication with the one or more controllers, wherein the one or more controllers are further configured to:
receive first accelerometer data from the at least one accelerometer; and
receive second accelerometer data from the at least one accelerometer;
wherein sending at least the first command signal to the one or more actuators to rotate the first canard from the first angle to the second angle includes sending, in response to at least receiving the first accelerometer data from the at least one accelerometer, at least the first command signal to the one or more actuators to rotate the first canard from the first angle to the second angle;
wherein sending at least the second command signal to the one or more actuators to rotate the first canard from the second angle to the third angle includes sending, in response to at least receiving the second accelerometer data from the at least one accelerometer, at least the second command signal to the one or more actuators to rotate the first canard from the second angle to the third angle.

8. The aerodynamic system of claim 1, wherein the one or more actuators include:
a hydraulic cylinder having a piston and piston rod, the piston rod being in mechanical communication with the first canard;
a hydraulic pump operably coupled to the hydraulic cylinder;
a hydraulic pump actuator constructed and arranged to actuate the hydraulic pump so that the hydraulic cylinder rotates the first canard about the rotational axis generally perpendicular to the first surface of the body.

9. The aerodynamic system of claim 1, wherein the one or more actuators include:
an electric motor in rotational communication with the first canard, the electric motor being constructed and arranged to rotate the first canard about the rotational axis generally perpendicular to the first surface of the body.

10. An aerodynamic system, comprising:
a first canard extending from a first surface of a body of an automobile;
one or more actuators operably coupled to the first canard, the one or more actuators being configured at least to rotate the first canard about a rotational axis extending through the first surface of the body;
one or more controllers in operable communication with at least the one or more actuators, wherein the one or more controllers are configured at least to:
send at least a first command signal to the one or more actuators to rotate the first canard from a first angle to a second angle;
send at least a second command signal to the one or more actuators to rotate the first canard from the second angle to a third angle;
wherein the third angle is different than the first angle and the second angle.

11. The aerodynamic system of claim 10, further comprising:
at least one tachometer in operable communication with the one or more controllers, wherein the one or more controllers are further configured to:
receive first tachometer data from the at least one tachometer; and
receive second tachometer data from the at least one tachometer;
wherein sending at least the first command signal to the one or more actuators to rotate the first canard from the first angle to the second angle includes sending, in response to at least receiving the first tachometer data from the at least one tachometer, at least the first command signal to the one or more actuators to rotate the first canard from the first angle to the second angle;
wherein sending at least the second command signal to the one or more actuators to rotate the first canard from the second angle to the third angle includes sending, in response to at least receiving the second tachometer data from the at least one tachometer, at least the second command signal to the one or more actuators to rotate the first canard from the second angle to the third angle.

12. The aerodynamic system of claim 11, wherein the at least one tachometer includes at least one crankshaft sensor.

13. The aerodynamic system of claim 11, wherein the at least one tachometer includes at least one wheel speed sensor.

14. The aerodynamic system of claim 10, further comprising:
at least one steering angle sensor in operable communication with the one or more controllers, wherein the one or more controllers are further configured to:
receive first steering angle sensor data from the at least one steering angle sensor; and
receive second steering angle sensor data from the at least one steering angle sensor;
wherein sending at least the first command signal to the one or more actuators to rotate the first canard from the first angle to the second angle includes sending, in response to at least receiving the first steering angle sensor data from the at least one steering angle sensor, at least the first command signal to the one or more actuators to rotate the first canard from the first angle to the second angle;
wherein sending at least the second command signal to the one or more actuators to rotate the first canard from the second angle to the third angle includes sending, in response to at least receiving the second steering angle sensor data from the at least one steering angle sensor, at least the second command signal to the one or more actuators to rotate the first canard from the second angle to the third angle.

15. The aerodynamic system of claim 10, further comprising:
at least one brake fluid pressure sensor in operable communication with the one or more controllers, wherein the one or more controllers are further configured to:
receive first brake fluid pressure sensor data from the at least one brake fluid pressure sensor; and
receive second brake fluid pressure sensor data from the at least one brake fluid pressure sensor;
wherein sending at least the first command signal to the one or more actuators to rotate the first canard from the first angle to the second angle includes sending, in response to at least receiving the first brake fluid pressure sensor data from the at least one brake fluid pressure sensor, at least the first command signal to the one or more actuators to rotate the first canard from the first angle to the second angle;
wherein sending at least the second command signal to the one or more actuators to rotate the first canard from the second angle to the third angle includes sending, in response to at least receiving the second brake fluid pressure sensor data from the at least one brake fluid pressure sensor, at least the second command signal to the one or more actuators to rotate the first canard from the second angle to the third angle.

16. The aerodynamic system of claim 10, further comprising:
at least one accelerometer in operable communication with the one or more controllers, wherein the one or more controllers are further configured to:
receive first accelerometer data from the at least one accelerometer; and
receive second accelerometer data from the at least one accelerometer;
wherein sending at least the first command signal to the one or more actuators to rotate the first canard from the first angle to the second angle includes sending, in response to at least receiving the first accelerometer data from the at least one accelerometer, at least the first command signal to the one or more actuators to rotate the first canard from the first angle to the second angle;
wherein sending at least the second command signal to the one or more actuators to rotate the first canard from the second angle to the third angle includes sending, in response to at least receiving the second accelerometer data from the at least one accelerometer, at least the second command signal to the one or more actuators to rotate the first canard from the second angle to the third angle.

17. The aerodynamic system of claim 10, wherein the one or more actuators include:
a hydraulic cylinder having a piston and piston rod, the piston rod being in mechanical communication with the first canard;
a hydraulic pump operably coupled to the hydraulic cylinder;
a hydraulic pump actuator constructed and arranged to actuate the hydraulic pump so that the hydraulic cylinder rotates the first canard about the rotational axis generally perpendicular to the first surface of the body.

18. The aerodynamic system of claim 10, wherein the one or more actuators include:
an electric motor in rotational communication with the first canard, the electric motor being constructed and arranged to rotate the first canard about the rotational axis generally perpendicular to the first surface of the body.

19. An aerodynamic system, comprising:
a first canard extending from a first surface of a body of an automobile;
one or more actuators operably coupled to the first canard, the one or more actuators being configured at least to rotate the first canard;
one or more controllers in operable communication with at least the one or more actuators, wherein the one or more controllers are configured at least to:
send at least a first command signal to the one or more actuators to rotate the first canard from a first angle to a second angle;
send at least a second command signal to the one or more actuators to rotate the first canard from the second angle to a third angle;
wherein the third angle is different than the first angle and the second angle.

20. The aerodynamic system of claim 19, wherein the one or more actuators include:
an electric motor in rotational communication with the first canard, the electric motor being constructed and arranged to rotate the first canard about the rotational axis generally perpendicular to the first surface of the body.
